(19) United States
(12) Patent Application Publication
(10) Pub. No.: US 2007/0228839 A1
(43) Pub. Date: Oct. 4, 2007

(54) Connector

(75) Inventor: Steven Yang, Taipei Hsien (TW)

Correspondence Address: BACON & THOMAS, PLLC, 625 SLATERS LANE, FOURTH FLOOR, ALEXANDRIA, VA, 22314, US

(73) Assignee: MICON PRECISE CORPORATION, Taipei Hsien (TW)

(21) Appl. No.: 11/395,314

(22) Filed: Apr. 3, 2006

(51) Int. Cl. B23K 11/24; H04B 7/185; H01R 29/00; H01P 1/10

(52) U.S. Cl. 307/112; 333/101; 439/43; 455/13.3

(57) ABSTRACT

The present invention is to provide a connector, which includes a casing; a first signal transmitting unit having a portion protruded from the casing and another portion extended into the casing; a second signal transmitting unit disposed in the casing and electrically coupled to the first signal transmitting unit; a third signal transmitting unit movably installed in the casing and having a portion insulatedly coupled to the second signal transmitting unit. If a portion of the third signal transmitting unit is pushed, the second signal transmitting unit will electrically disconnect the first signal transmitting unit, and another portion of the third signal transmitting unit will electrically connect the second signal transmitting unit.

### FIELD OF THE INVENTION

The present invention relates to a connector, and more particularly to a connector for connecting two different antennas for different conditions of transmitting signals at the same time that comes with a simple structure and a low manufacturing cost.

### BACKGROUND OF THE INVENTION

In recent years, various electronic and information products advance, and electronic components of these products tend to have a light, thin, short, compact and dense design, and thus the signal transmissions among these electronic devices become very important. For example, it is common for a multifunctional printed circuit board (PCB) to have a signal switch connector for transmitting signals among different electronic components and modules on the printed circuit board as well as providing a socket for plugging a connector of the electronic devices and transmitting signals with the printed circuit board.

For example, a traditional connector disclosed in R.O.C. Pat. Application No. 92206439 entitled “a coaxial connector with a switching function” comprises a bushing, a first, a second and a third insulating members, a central conducting body, and a contacting member. The central conducting body includes a first conducting member and a second conducting member connected with each other, and the first conducting member can be moved axially between a first position and a second position. At the first position, the first conducting member is coupled to the contacting member, and at the second position, the first conducting member is disposed away from the contacting member and not connected to the contacting member. The coaxial connector achieves its switching function by moving and switching the first conducting member between the first and second positions.

Further, the structure of a signal switch connector as disclosed in R.O.C. Pat. Application No. 94219748 comprises a first connecting terminal having a protruded end disposed on the surface of a casing through a first insulator and another protruded end extended into the casing; a second connecting terminal having a protruded end disposed outside another distal opening of the casing through a second insulator and another protruded end extended into the casing with a certain specific length, such that the protruded end is extended precisely into a groove of an inserting terminal, and the groove contains a first resilient member; and the inserting end of the inserting terminal is disposed in a distal opening of the casing, and an external edge at the middle section of the inserting terminal includes a flange, and a sidewall of the flange has a third insulator, and the external edge of the third insulator includes another flange, and a sidewall of the other flange includes a second resilient member installed between the sidewall of the other flange and the second insulator, so that if the first and second resilient members have not been compressed, the other sidewall of the flange of the inserting terminal will be in contact with another protruded end, and if the inserting end is inserted by an external connector, the external connector will be in contact with the inserting end and the first and second resilient members will be compressed, and finally the other sidewall of the flange of the inserting terminal will be separated from another protruded end of the first connecting terminal.

Further, an antenna connector as disclosed in R.O.C. Pat. Application No. 93220265 comprises a casing, a connecting portion movably disposed at an end of the casing, and a second signal transmitting portion movably disposed at another end of the casing. Further, the surface of the casing includes a first signal transmitting portion coupled to the connecting portion for transmitting signals, and the second transmitting portion can be connected to the connecting portion and the connecting portion can be separated from the second transmitting portion, and the second signal transmitting portion and the connecting portion will take over the signal transmission, such that the antenna connector provides different ways of transmitting signals.

However, all of the aforementioned patents come with a structure of relatively complicated components and a high manufacturing cost, which are not cost-effective. Therefore, designing a connector different from the prior art to overcome the foregoing shortcomings of the prior is desirable to both manufacturers and users.

### SUMMARY OF THE INVENTION

In view of the shortcomings of the prior art antenna connector that provides a signal transmitting method only, and has a very limited scope for its applications that cannot be used for connecting different antennas for different conditions of transmitting signals at the same time, the inventor of the present invention based on years of experience in the related field to conduct extensive researches and experiments, and finally designed an antenna connector in accordance with the present invention to overcome the shortcomings of the prior art.

Therefore, it is a primary objective of the present invention to provide a connector comprising: a casing; a first signal transmitting unit disposed at the surface of the casing, and a portion of the first signal transmitting unit being protruded from the casing and another portion extended into the casing; a second signal transmitting unit disposed in the casing, and the second signal transmitting unit being movably and electrically coupled to the first signal transmitting unit; a third signal transmitting unit movably installed in the casing, and a portion of the third signal transmitting unit insulatedly coupled to the second signal transmitting unit, such that if a portion of the third signal transmitting unit is pushed, then the second signal transmitting unit will be electrically disconnected from the first signal transmitting unit, and another portion of the third signal transmitting unit being electrically connected to the second signal transmitting unit, such that if the third signal transmitting unit is not pushed, then another portion of the third signal transmitting unit will be electrically disconnected from the second signal transmitting unit, and the second signal transmitting unit will be movably and electrically coupled to the first signal transmitting unit again.

The above and other objects, features and advantages of the present invention will become apparent from the following detailed description taken with the accompanying drawings.

### BRIEF DESCRIPTION OF THE DRAWINGS

FIG. 1 is an exploded view of an antenna connector of the invention;

FIG. 2 is a cross-sectional view an antenna connector installed in a casing of the invention; and

FIG. 3 is another cross-sectional view an antenna connector installed in a casing of the invention.

### DETAILED DESCRIPTION OF THE PREFERRED EMBODIMENTS

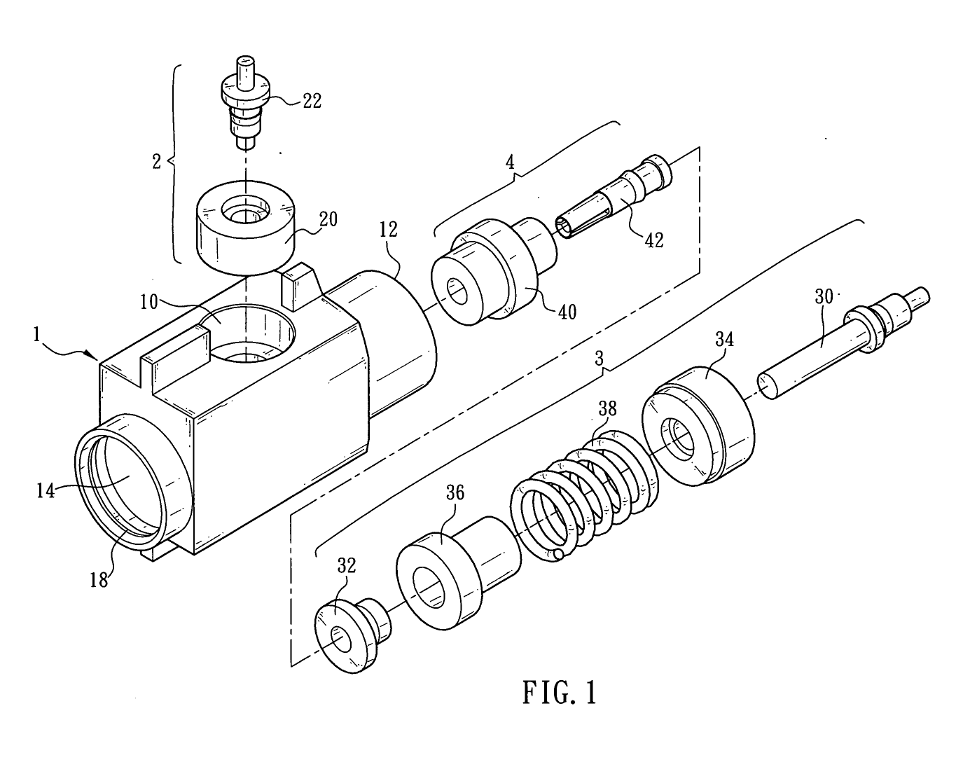

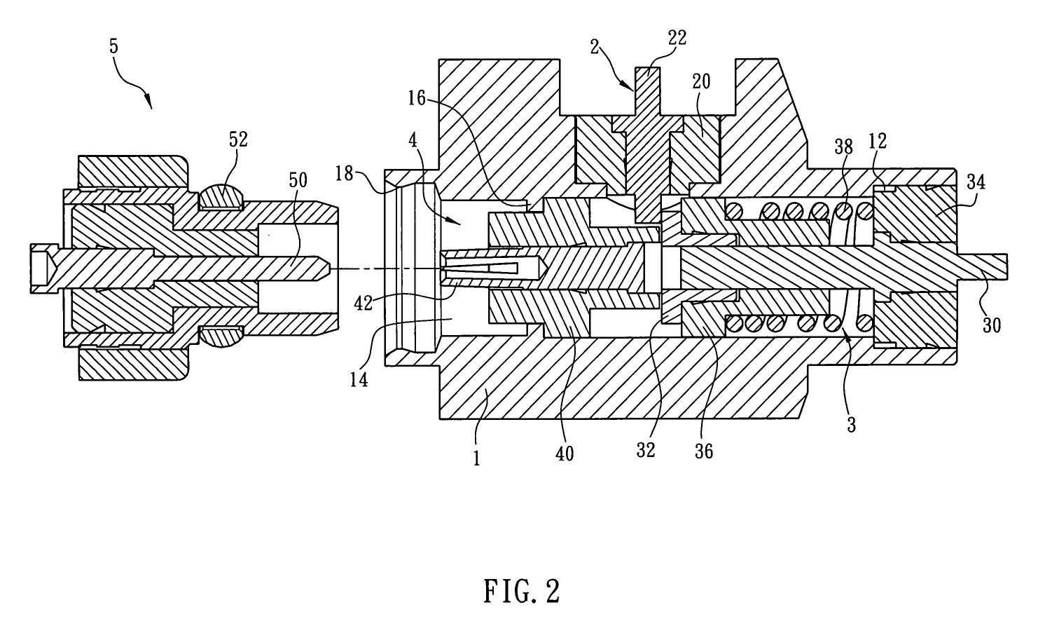

Referring to FIGS. 1 and 2 for a connector of the present invention, the connector comprises: a casing 1; a first signal transmitting unit 2 disposed on the surface of the casing, and a portion of the first signal transmitting unit 2 being protruded out from the casing 1 and another portion of the first signal transmitting unit being extended into the casing 1; a second signal transmitting unit 3 disposed in the casing 1 and movably and electrically coupled to the first signal transmitting unit 2; a third signal transmitting unit 4 movably disposed in the casing 1, and a portion of the third signal transmitting unit 4 being insulatedly coupled to the second signal transmitting unit 3, such that after a portion of the third signal transmitting unit 4 is pushed, the third signal transmitting unit 4 will be electrically disconnected from the first signal transmitting unit 2, and another portion of the third signal transmitting unit 4 will be electrically coupled to the second signal transmitting unit 3. If the third signal transmitting unit 4 has not been pushed, another portion of the third signal transmitting unit 4 will be electrically disconnected from the second signal transmitting unit 3, and the second signal transmitting unit 3 will be movably and electrically coupled to the first signal transmitting unit 2 again.

In a preferred embodiment of the present invention, the first signal transmitting unit 2 includes a first insulating portion 20 disposed on the surface of the casing 1, and the first signal transmitting unit 2 includes a first conducting portion 22 disposed in the first insulating portion 20, and an end of the first conducting portion 22 is protruded out from the casing 1 and another end of the first conducting portion 22 is extended into the casing 1 and disposed proximate to the central position in the casing 1.

In the preferred embodiment, the second signal transmitting unit 3 includes a second conducting portion 30 disposed in the casing 1, and an end of the second conducting portion 30 is protruded out from an end of the casing 1, and another end of the second conducting portion 30 is extended towards another end of the casing 1 and disposed at a position proximate to the first signal transmitting unit 2, and the second signal transmitting unit 3 includes a bushing 32 movably sheathed onto the periphery at another end of the second conducting portion 30, and another end of the bushing 32 facing the first conducting portion 22 is coupled to the first conducting portion 22.

In the preferred embodiment, the second signal transmitting unit 3 further includes a second insulating portion 34, a third insulating portion 36 and a resilient member 38, wherein the second insulating portion 34 is disposed at an end of the casing 1, and an end of the second conducting portion 30 is passed through an end of the second insulating portion 34 that is protruded out from the casing 1, and the second conducting portion 30 is coupled to the second insulating portion 34, and the second conducting portion 30 is securely fixed to the second insulating portion 34, and the third insulating portion 36 is sheathed onto the bushing 32 and disposed proximate to the periphery of the second conducting portion 30, and the second conducting portion 30 is disposed between the bushing 32 and a portion of the periphery of the second insulating portion 34, and an end of the third insulating portion 36 facing the second insulating portion 34 keeps a specific distance from the second insulating portion 34, and the resilient member 38 is installed between the second insulating portion 34 and the third insulating portion 36.

In the preferred embodiment, a portion of the third signal transmitting unit 4 constitutes a fourth insulating portion 40, and the fourth insulating portion 40 is movably disposed in the casing 1, and an end of the fourth insulating portion 40 is coupled to the bushing 32 and another end of the fourth insulating portion 40 is extended to a position proximate to another end of the casing 1, and another portion of the third signal transmitting unit 4 constitutes a third conducting portion 42, and the third conducting portion 42 is inserted into the fourth insulating portion 40, and an end of the third conducting portion 42 is disposed between the fourth insulating portion 40 and another end of the casing 1, and another end of the third conducting portion 42 is extended to a position proximate to an end of the fourth insulating portion 40.

In the preferred embodiment, the casing 1 includes a hole 10 disposed at its periphery for precisely accommodating the first insulating portion 20, and an end of the casing 1 has an opening 12 for precisely accommodating the second insulating portion 34, and another end of the casing 1 has another opening 14 for receiving a portion of another connector 5 to be extended into the casing 1, and a conductor 50 of another connector 5 can be connected to the third conducting portion 42, and the fourth insulating portion 40 pushes the bushing 32, such that the bushing 32 is separated from the connecting position of the first conducting portion 22, and the casing 1 includes a stopping portion 16 disposed at another opening 14 and the first conducting portion 22. Further, the casing 1 includes a protruding portion 18 disposed proximate to the position of an external edge of the other opening 14, such that a portion of the other connector 5 is extended to the stopping portion 16 and cannot be extended further, and thus the fourth insulating portion 40 will not press against the first conducting portion 22, and an external edge of the other connector 5 has an elastic body 52 which is limited precisely by the protruding portion 18, and another connector will not come off easily from the other connector 5.

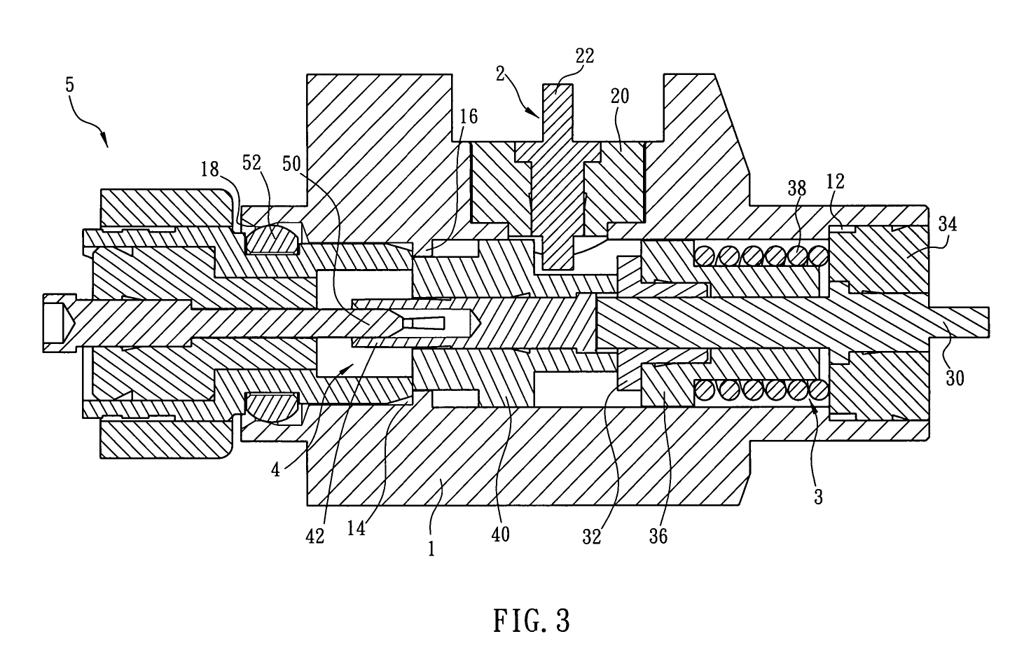

Referring to FIGS. 2 and 3 for the foregoing components, the connector of the invention can be connected by the following two methods:

1. Before another end of the connector is connected to the other connector 5, the resilience of the resilient member 38 is acted on the third insulating portion 36 and a force is pushed towards another end of the casing 1 for coupling the bushing 32 with the first conducting portion 22, so that a signal received by the first conducting portion 22 can be transmitted from the bushing 32 to the second conducting portion 30, and then transmitted out from an end of the casing 1 protruded from the second conducting portion 30.

2. After another end of the connector is connected to the other connector 5, the bushing 32 is pushed by the fourth insulating portion 40 to drive the third insulating portion 36 to move towards an end of the casing 1, so that the resilient member 38 will be compressed to expose the second conducting portion 30 out from the bushing 32 and further to couple the third conducting portion 42 to the second conducting portion 30. By then, a signal received by the third conducting portion 42 can be transmitted to the second conducting portion 30 and then transmitted out from an end of the casing protruded from the second conducting portion 30. If the fourth insulating portion 40 is not pushed towards an end of the casing 1, the resilience of the resilient member 38 will push the bushing 32 to be coupled to the first conducting portion 22 again.

While the invention has been described by means of specific embodiments, numerous modifications and variations could be made thereto by those skilled in the art without departing from the scope and spirit of the invention set forth in the claims.

What is claimed is:

1. A connector, comprising:
a casing;
a first signal transmitting unit, installed at a surface of said casing, and having a portion of said first signal transmitting unit protruded out from said casing and another portion of said first signal transmitting unit extended into said casing;
a second signal transmitting unit, installed on a side of said casing and movably and electrically coupled to said first signal transmitting unit; and
a third signal transmitting unit, installed on another side of said casing and having a portion of said third signal transmitting unit insulatedly coupled to said second signal transmitting unit, such that if a portion of said third signal transmitting unit is pushed, then said second signal transmitting unit will be electrically disconnected from said first signal transmitting unit, and another portion of said third signal transmitting unit electrically coupled to said second signal transmitting unit, such that if said third signal transmitting unit is not pushed, then said second signal transmitting unit will be movably and electrically coupled to said first signal transmitting unit again, and another portion of said third signal transmitting unit will be electrically disconnected from said second signal transmitting unit.

2. The connector of claim 1, wherein said first signal transmitting unit comprises:
a first insulating portion, disposed on a surface of said casing; and
a first conducting portion, inserted into said first insulating portion of said first signal transmitting unit and having an end of said first conducting portion protruded out from said casing and another end of said first conduction portion extended into said casing and disposed proximate to the central position of said casing.

3. The connector of claim 2, wherein said second signal transmitting unit comprises:
a second conducting portion, disposed in said casing and having an end of said second conducting portion protruded out from said casing and another end of said second conducting portion extended into said casing and disposed at a position proximate to said first signal transmitting unit; and
a bushing, movably sheathed onto another distal end of said second conducting portion and having an end of said bushing facing said first conducting portion coupled to said first conducting portion.

4. The connector of claim 3, wherein said second signal transmitting unit further comprises:
a second insulating portion, disposed at an end of said casing, and having an end of said second conducting portion passing through said second insulating portion and being protruded from an end of said casing, and said second conducting portion being coupled to said second insulating portion, and said second conducting portion being securely fixed to said second insulating portion;
a third insulating portion, sheathed onto said bushing at the periphery proximate to said second conducting portion and a portion of the periphery of said second conducting portion between said bushing and said second insulating portion, and an end of said third insulating portion facing said second insulating portion keeping a predetermined distance from said second insulating portion; and
a resilient member, installed between said second insulating portion and said third insulating portion.

5. The connector of claim 4, wherein said third signal transmitting unit comprises:
a fourth insulating portion, movably disposed in said casing and having an end of said fourth insulating portion coupled to said bushing and another end of said fourth insulating portion extended to a position proximate to another end of said casing; and
a third conducting portion, inserted into said fourth insulating portion and having an end of said third conducting portion disposed between said fourth insulating portion and said casing and another end of said third conducting portion extended to a position proximate to said insulating portion.

6. The connector of claim 5, wherein said casing comprises:
a hole, disposed at the periphery of said casing for containing said first insulating portion;
an opening, disposed at an end of said casing for containing said second insulating portion; and
another opening, disposed at another end of said casing for receiving a portion of said other connector extended into said casing.

7. The connector of claim 6, wherein said casing comprises a stopping portion disposed between said other opening and a position proximate to said first conducting portion, and a portion of said other connector is extended to said stopping portion and cannot be extended further, so that said fourth insulating portion will not press against said first conducting portion.

8. The connector of claim 7, wherein said casing includes a protruding portion disposed at an external edge of said other opening.
